(19) United States
(12) Patent Application Publication
(10) Pub. No.: US 2023/0200482 A1
(43) Pub. Date: Jun. 29, 2023

(54) LED-BASED CONFIGURATIONS FOR CHANGEABLE COLOR FOOTWEAR

(71) Applicant: Kaitlyn Sue Marley, Hazle Township, PA (US)

(72) Inventor: Kaitlyn Sue Marley, Hazle Township, PA (US)

(21) Appl. No.: 18/084,653

(22) Filed: Dec. 20, 2022

Related U.S. Application Data
(60) Provisional application No. 63/294,655, filed on Dec. 29, 2021.

(51) Int. Cl. A43B 3/36; F21V 33/00; F21V 23/04; F21L 4/02; F21V 23/00

(52) U.S. Cl. CPC A43B 3/36; F21L 4/02; F21V 23/003; F21V 23/0435; F21V 33/0008; F21Y 2115/10

(57) ABSTRACT

Footwear including an external LED-based lighting arrangement is described, where the lighting arrangement is coupled to the outer surface of the footwear and controlled to change the color appearance of the footwear as desired. The lighting arrangement may use individual LEDs, strings of LEDs, or optical fibers illuminated by LEDs. The arrangement may be directly attached to the surface of the footwear, or embedded within a covering that may be removably attached to the footwear.

### CROSS-REFERENCE TO RELATED APPLICATIONS

This application claims priority from U.S. Provisional Application No. 63/294,655, filed Dec. 29, 2021 and herein incorporated by reference.

### TECHNICAL FIELD

The present invention relates to footwear and, more particularly, to footwear including an external arrangement for changing the color of the footwear as desired.

### BACKGROUND OF THE INVENTION

Many dancers participate in more than one routine per year and prefer to reuse their shoes from one time to the next, for comfort and fit reasons as well as saving on expenses. However, there is often a need to purchase new shoes (and perhaps multiple pairs of shoes) to coordinate with the color of a particular costume, routine, or the like. As a result, a dancer may spend a large sum of money on the purchase of new shoes every year.

Past attempts at avoiding this expense include using various colors of shoe polish to change the look of the shoes, or perhaps dyeing the shoes. Some dancers have been known to use spray paint to update the color of their shoes, with mixed results. The colors may bleed, or cracks may develop in the coating as the shoes are worn. In any event, these attempts to change the color of the footwear material itself can only be used a few times (at best) before the material degrades and the footwear must be discarded.

### SUMMARY OF THE INVENTION

The needs remaining in the art are addressed by the present invention, which relates to footwear and, more particularly, to footwear including an external LED-based lighting arrangement coupled to the outer surface of the footwear for changing the color of the footwear as desired. A placement component, as described below, is used to support the lighting arrangement.

While initially conceived to address the particular concerns of dancers that need to change the color of shoes time after time, the arrangement of the present invention may be utilized with any footwear and used to change the color as desired.

An exemplary embodiment of the present invention may take the form of one or more strings of LEDs, where various strings illuminate with a different color. The strings are attached to the outer surface of the footwear at various locations via the placement component and powered by a switch-controlled battery source to turn “on” the color(s) as desired at a particular time. Changing the switch arrangement thus changes the specific LED strings that are energized and changes the color appearance of the footwear.

Another embodiment of the present invention proposes to utilize a placement component that takes of the form of a transparent material (e.g., plastic), with the LEDs embedded within or attached to the transparent material. Thereafter, the transparent placement component is used as an outer covering for the shoe itself. Similar to the above embodiment, a battery-controlled switching arrangement is used to change the color of the shoes as need.

Yet another embodiment is directed to the provision of a shoe covering (“skin”) type of placement component that is formed of a fabric woven to include lengths of optical fibers. The optical fibers are long enough to extend beyond the edge of the fabric, where they are collected together and attached to a lighting component that includes multiple LEDs (of different colors). Different sets (bundles) of optical fibers are coupled to each LED and again controlled through a switching arrangement to change the color appearance of the footwear by changing the color of the fabric skin covering the footwear.

Other and further embodiments and aspects of the present invention will become apparent during the course of the following discussion and by reference to the accompanying drawings.

### BRIEF DESCRIPTION OF THE DRAWINGS

Referring now to the drawings, where like numerals represent like parts in several views,

FIG. 1 illustrates an exemplary embodiment of the present invention, in the case comprising individual LEDs attached to the footwear itself;

FIG. 2 depicts a typical section of LED “rope”, which consists of a string of LEDs disposed within a length of transparent plastic tubing;

FIG. 3. illustrates an exemplary embodiment of the present invention that utilizes the LED rope as shown in FIG. 2;

FIG. 4 is an alternative configuration of the embodiment of FIG. 3, where in this case the individual LEDs within a section of rope may illuminate with different colors, providing a different type of color appearance for the footwear;

FIG. 5 shows another embodiment of the present invention, where the attachment component takes the form of a transparent type of shoe covering, with the LED lighting arrangement either embedded within or attached to the attachment component itself;

FIG. 6 illustrates yet another embodiment of the present invention, in this case where the attachment component comprises a fabric-based shoe skin that incorporates a plurality of individual optical fibers, with a set of LEDs coupled to the optical fibers in a manner that the shoe skin may be controlled to create different color appearances of the footwear;

FIG. 7 is a view of the fabric-based shoe skin of FIG. 6, showing a power source that is attached to a coupler and used to energize the LEDs;

FIG. 8 is a close-up view of an end termination of the inventive shoe skin, showing the illumination as presented by the optical fibers woven into the fabric itself; and

FIG. 9 shows a pair of shoes prepared in accordance with the present invention, where each shoe includes a covering of the inventive skin and controlled to emit a different.

### DETAILED DESCRIPTION

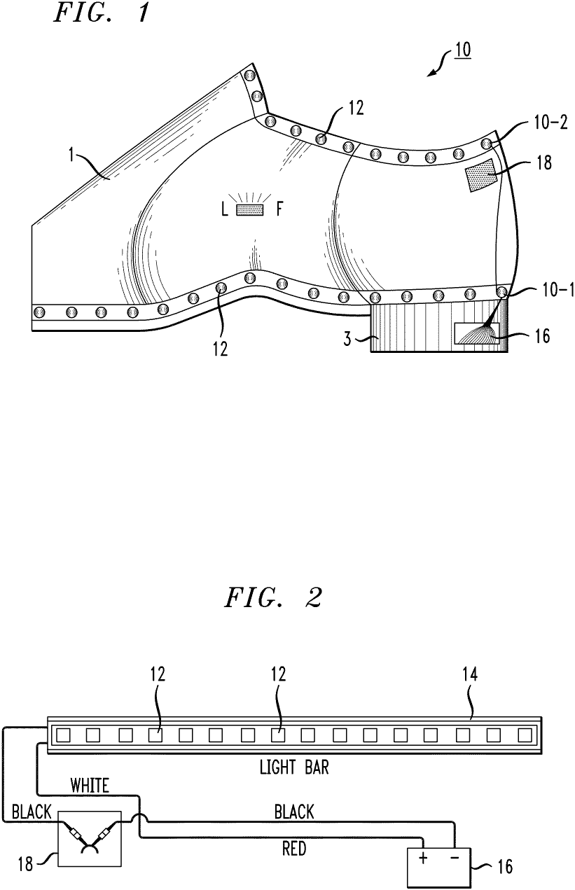

FIG. 1 illustrates an exemplary embodiment of the present invention, in this case based upon the utilization of discrete, individual LED devices that are attached to the footwear itself (attached either permanently, or with a releasable attachment configuration). In particular, FIG. 1 shows an LED-based lighting arrangement 10 as positioned around typical footwear 1. In this particular embodiment, a first string of discrete LEDs 10-1 is disposed around the periphery of the region where the sole meets the body of footwear 1. A second string of discrete LEDs 10-2 is disposed around an upper termination of the body of footwear 1. These positions are exemplary only and various strings of LEDs may be positioned at any desired location on and around the footwear, as along as when energized the amount of light created is sufficient to give the effect of changing the color of the shoe.

In one configuration of the present invention, individual LEDs 12 may be electrically coupled together and disposed within a clear plastic tubing 14, as shown in FIG. 2. This type of configuration is often referred to as an “LED rope.” A battery source 16 may be disposed in an interior portion of footwear 1 (for example, in heel area 3 as shown in FIG. 1), with an external switch 18 that is used by the wearer to energize the LEDs when desired to change the color of the shoe. With respect to the battery itself, it is contemplated that shoes utilizing the LED-based lighting arrangements of the present invention may be “rechargeable” at a convenient charging station. For example, at a dance studio where multiple individuals are all using the inventive arrangement, any shoes not being used at a given point in time may be plugged into the charging station. Indeed, in a performance setting, it is contemplated that having such a charging station back stage would be extremely useful to ensure full battery life for an especially long dance routine.

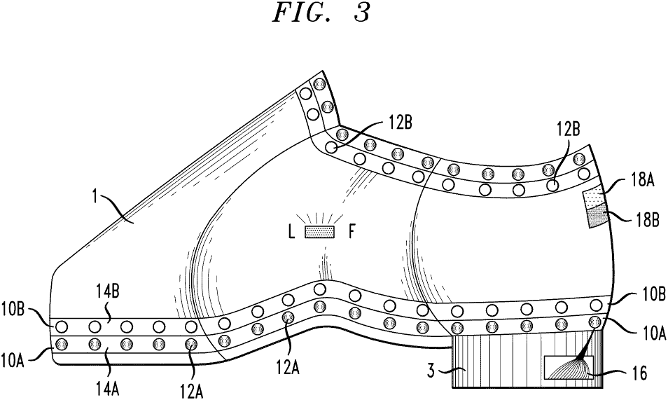

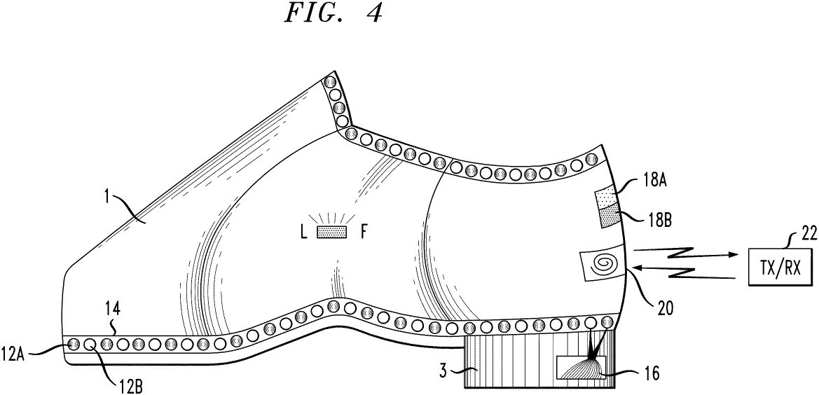

An aspect of the present invention is to provide the capability of creating many different shoe colors, allowing the individual to tailor the result in any manner. Indeed, the original concept was predicated upon the needs of a dancer to have shoes of many different colors for the various routines that are performed. The expense of having so many pairs of shoes is unwieldy, leading the inventor to derive the LED-based methodology for quickly and easily changing the color of dance shoes by attaching LEDS that emit at different colors onto the shoe itself. FIG. 3 illustrates an embodiment that illustrates the use of separate LED strings for this purpose. In this case, a first LED-based arrangement 10A is similar to that described above, with a second LED-based arrangement 10B also placed around footwear 1. Here, individual LEDs 12B of second arrangement 10B emit a different color. Switch 18 is shown in this example to include a pair of separate switches 18A, 18B, with each switch designated to activate a separate one of the individual LED-based arrangements 10A, 10B. In this example, therefore, it is possible to energize either arrangement separately, or both at the same time, thus creating different coloring results.

FIG. 4 shows an alternative embodiment of discrete LED-based lighting arrangement 10, where in this arrangement LEDs of different colors (designated 12A and 12B) are included along the same string, but again have independent switches to control the lighting effect in manner similar to the arrangement of FIG. 3. Also shown in this embodiment is a wireless controller 20 that may be used instead of (or in additional to) switches 18A, 18B to control the turning “off” and “on” of LEDs 12A, 12B. In particular, wireless controller 20 is shown as being in communication with a wireless transceiver 22 (which may take the form of a conventional remote control unit, a smartphone app, or any other means of providing wireless communication with LED-based lighting arrangement 10. Such a remote control may be particularly useful in dance routine applications, allowing for changes in the color of the dancers’ footwear to be choreographed to match a routine, or changed by a dance instructor. Obviously, an embodiment where multicolored LEDs within multiple strings (that is, combining the aspects of FIGS. 3 and 4) may be used as well. Indeed, it is contemplated that virtually any desired footwear coloring may be created by the proper choice of LED(s).

It is contemplated that a variety of different configurations may be used to attach the LEDs to the footwear. In the examples above, the LED-filled tubing may be removably attached to the footwear (using clips, hook-and-loop fasteners, or the like). In another embodiment, transparent tubing may be permanently affixed to the footwear to form the attachment component of the lighting arrangement, and LED strings “laced” through the tubing to provide the arrangement. Indeed, the LED strings may be used as part of conventional tie-shoe lacing, if appropriate.

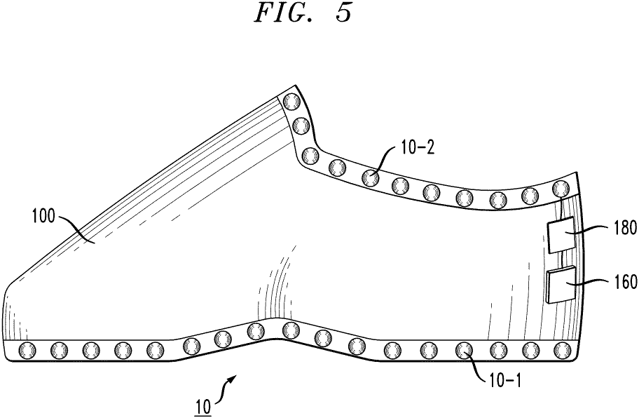

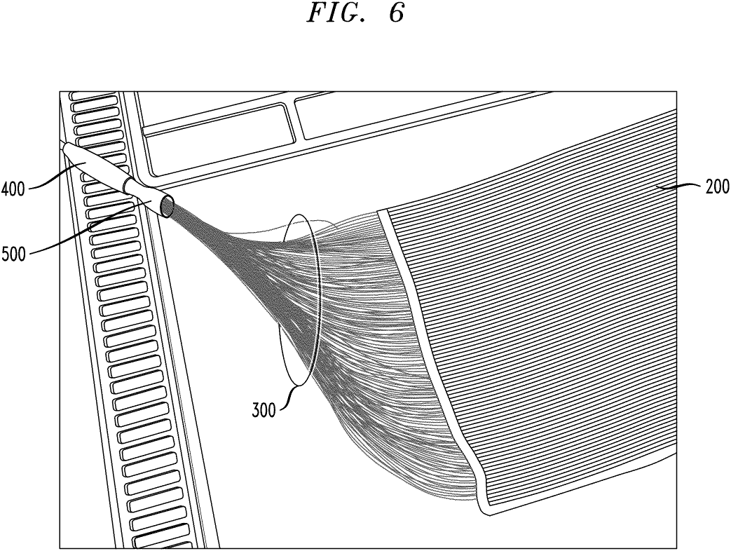

Another embodiment of the present invention is based upon the use of a transparent shoe covering as the attachment component of the lighting arrangement, and is formed to include the individual LEDs, where the covering is placed over a basic (preferably neutral-colored) shoe to provide the color changing capability. FIG. 5 shows an exemplary covering 100 that is formed to include LED-based lighting arrangement 10 as described above, except in this case a battery source 160 and switch 180 are also formed on covering 100. Covering 100 is preferably flexible and is placed over the footwear and held in place by any suitable means. Inasmuch as all of the components are assembled with covering 100, it is relatively simple to use the same covering with different shoes, as desired. Similar to the arrangements described above, it is contemplated that a set of coverings 100 may all be plugged into a charging station when not in use, ensuring that they will be fully charged and ready for a practice or performance.

Yet another “shoe covering” type of embodiment of the present invention is shown in detail in FIGS. 6 - 9. This embodiment is based upon the use of individual optical fibers that are woven within a piece of fabric that is used as a shoe covering. Similar to novelty items, various groups of the individual fibers within the fabric may be illuminated by different color LEDs, where the particular arrangement of fibers along a length of material may be configured to provide any desired color arrangement. In one case, adjacent fibers may be attached to different LED sources and “glow” with different colors; groups of adjacent LEDs may also be coupled to the same LED (providing more of a “stripe” arrangement of colors), etc.

FIG. 6 shows an exemplary piece of material 200 (i.e., a piece of neutral color fabric) that may be used as a shoe covering (referred to here as a “shoe skin”, or simply “skin), and a plurality of individual optical fibers 300 that are woven within the warp and weft of the material itself. The distal termination of the plurality of fibers 300 are collected within a coupler 400, with a set of different-colored LEDS 500 also attached to coupler 400. As mentioned above, different groups of the individual fibers 300 may be coupled to the various LEDs to create the various (as well as variable) color presentation on skin 200.

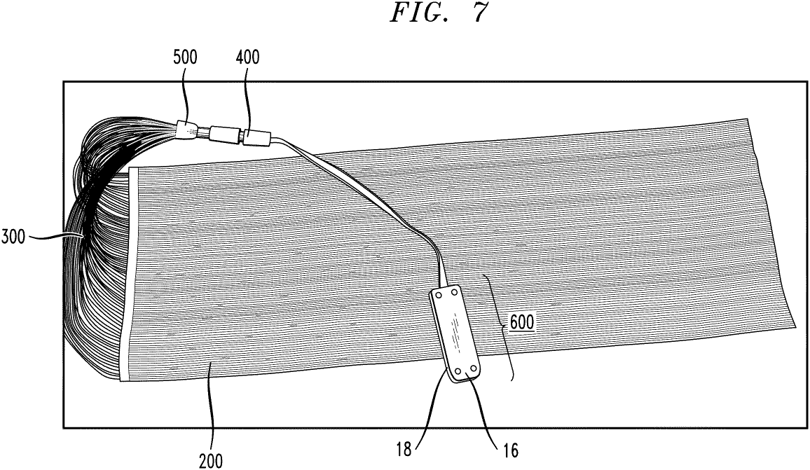

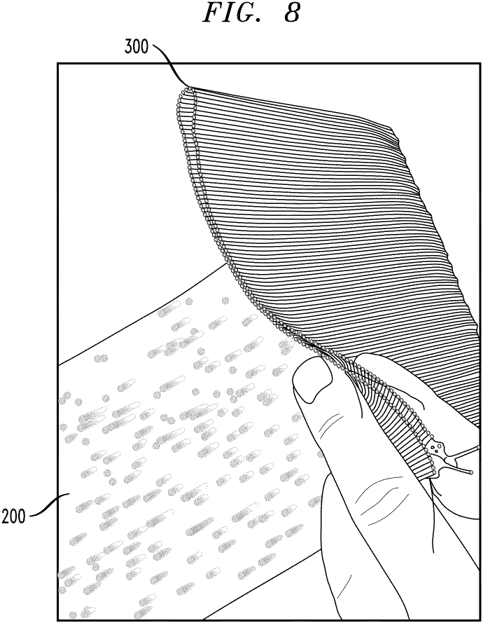

FIG. 7 is a view of skin 200, showing a power source 600 that is attached to coupler 400 and used to energize the LEDs. The resultant “glow” output from LEDS 500 near the distal terminations of fibers 300 is evident in this view. Additionally, a light/dark pattern is evident on skin 200, which corresponds to the presence of different colors along the length of material 200, a result of various ones of the woven-in optical fibers being illuminated. Like the above-described embodiments, the power supply of the fabric-based shoe skin of this embodiment may easily be maintained at a full power level by having a charging station located at the same venue where the invention is being used.

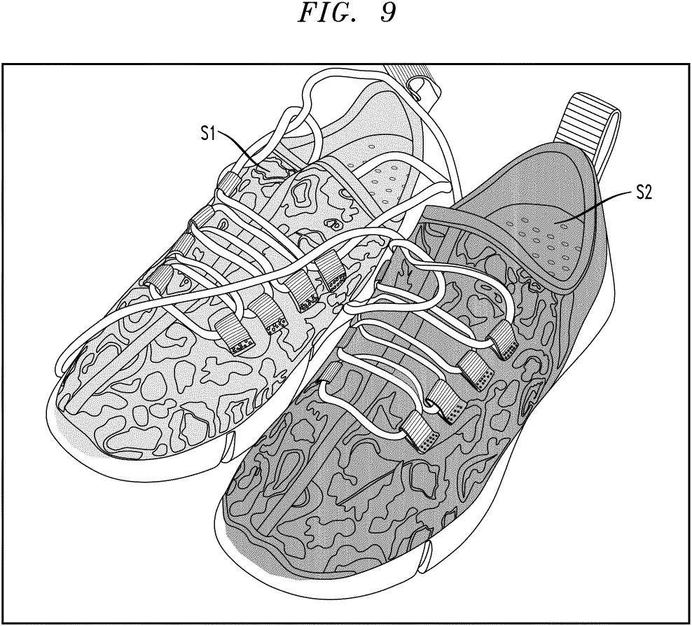

FIG. 8 is a close-up view of an end termination of the inventive shoe skin, showing the illumination as presented by optical fibers 300 within material 200. Lastly, FIG. 9 shows a pair of shoes S1 and S2, where each shoe includes a covering of skin 200 formed in accordance with the principles of the present invention. Shoe S1 has been controlled to create a first color appearance for shoe S1 by controlling coupler 400 to turn on a selected color (or colors) of LEDs 500. A different set of LEDs 500 has been turned “on” for the color appearance of the same skin 200 as covering shoe S2.

Although the present invention has been described with reference to several preferred embodiments, it will be understood that the invention is not limited to the details described therein. Indeed, various substitutions and modifications have been mentioned in the description and others may occur to those skilled in the art. Therefore, all such modifications and substitutions are considered to fall within the scope of the present invention as defined by the following claims.

What is claimed is:

1. Apparatus for providing changeable color footwear, comprising
a plurality of light emitting diodes (LEDs), with individual sets of LEDs within the plurality configured to emit at different colors;
a placement component for distributing the location of the different colors from the plurality of LEDs across an external portion of a footwear product;
a battery source coupled to the plurality of LEDs to enable illumination; and
a switching arrangement disposed between the plurality of LEDs and the battery source to control the selection of individual sets of LEDs of different color that are illuminated at any point in time, providing for a changeable color appearance of the footwear.

2. The apparatus as defined in claim 1 wherein the plurality of LEDs are configured as a collection of individual strings of LEDs.

3. The apparatus as defined in claim 2 wherein the placement component comprises a plurality of releasable attachment elements disposed along separation locations of each individual string of the collection of individual strings, the plurality of releasable attachment elements joining with like elements on the footwear external surface to provide the ability to attach or remove an individual string of LEDs to/from the external surface of the footwear.

4. The apparatus as defined in claim 2 wherein the placement components comprises an adhesive for providing attachment of the collection of individual strings of LEDs to desired locations on the external surface of the footwear.

5. The apparatus as defined in claim 2 wherein one or more of the individual strings of LEDs are disposed in transparent plastic tubing.

6. The apparatus as defined in claim 1, wherein the placement component comprises a transparent cover for attachment to the footwear, with the collection of individual strings of LEDs attached to the transparent cover.

7. The apparatus as defined in claim 1, wherein the placement component comprises a plurality of optical fibers woven within a fabric to form a shoe skin, wherein the plurality of LEDs are remotely located at a distal termination of the plurality of optical fibers, with different bundles of individual optical fibers coupled to different-colored LEDs.

8. The apparatus as defined in claim 1, wherein the battery source and the switching arrangement are co-located with the plurality of LEDs.

9. The apparatus as defined in claim 8, wherein the apparatus further comprises a wireless switch controller, used to control the setting of the switching arrangement to change a color appearance of the footwear from a remote location.

10. The apparatus as defined in claim 1, wherein the battery source is configured to be rechargeable by a co-located charging station.
